(19) United States
(12) Patent Application Publication
(10) Pub. No.: US 2002/0143823 A1
(43) Pub. Date: Oct. 3, 2002

(54) Conversion system for translating structured documents into multiple target formats

(76) Inventor: Mark A. Stevens, Darien, IL (US)

Correspondence Address: Richard L. Sampson, Sampson & Associates, P.C., 50 Congress Street, Boston, MA, 02109, US

(21) Appl. No.: 09/766,335

(22) Filed: Jan. 19, 2001

(51) Int. Cl. G06F 17/22; G06F 17/21

(52) U.S. Cl. 707/523; 707/513

(57) ABSTRACT

A translator, system, and method of translation is provided for translating a source file in a source format to a target file in a target format. A feature identifier determines a feature set of the source file, and a feature writer writes the feature set into the target file in the target format. Optionally, the feature identifier may include a front-end lookup table to map code fragments of the source file to a list of features. The feature writer may include a back-end lookup table to map the feature set to code fragments of the target file format.

### BACKGROUND INFORMATION

Software translation systems developed by the assignee of the present application and other companies may use lookup tables or symbol tables at the “front-end” of the system, i.e., to read a source file. A typical table-based translation contains an ad-hoc table of items to be read from the source format. The items in the table are usually very closely tied to the lexicon and syntax of the source format. By modifying the table, the user may accommodate minor differences between different source formats. Disadvantageously, however, these lookup tables have difficulty handling more substantial differences in syntax. Part of a conventional table is shown below.

{crmtEnd} “*/”

{cmtSt} “/*”

Whenever the program reads “/*”, it interprets that as a comment beginning. Whenever the program reads “*/”, it interprets that as a comment ending.

More sophisticated translation tools often break the read process into two stages, each of which may be table-based. The first stage, referred to as a lexical analyzer, breaks the input into logical units called tokens. The second stage then assigns meaning to the tokens. The languages LEX and YACC are examples of such a lexical analyzer and parser. Even in these sophisticated languages it is difficult to read some common language constructs. Moreover, although this front-end arrangement may permit a user to specify some lexical and syntactic differences between source formats, they generally do not permit a user to input source files of different overall structure. Moreover, these translation tools may use a table for the front-end of the translation, but not the back-end (i.e., the output end) of the translator. For these reasons, such translators do not permit a user to translate multiple input formats to multiple output formats, but rather, are generally language-specific.

These drawbacks generally stem from their use of the conventional approach of mapping particular commands to particular functions. This approach creates an often artificial one-to-one mapping of statements in one language to statements in another language. The meaning of the statements are irrelevant in these translations except that particular statements in the source format translate to particular statements in the target format.

This one-to-one mapping is similar to the approach generally used by compilers. For example, a compiler reads the internal representation of a program command by command. It looks each command up in a code generation table and looks variables up in a symbol table. For each command it substitutes a sequence of machine instructions found in the code generation table. As the compiler encounters variables in the instruction sequence, it looks the variables up in the symbol table and either locates the data in registers or assigns relocatable memory addresses to the data. Conventional code optimization routines may also be used before the back-end.

In addition, compilers generally translate to a context-free grammar. Such a grammar allows the source format (syntax) to be read as a “tree” structure, to effectively “de-nest” nested functions prior to sequentially writing instructions. In such a tree structure, elements that are defined in terms of other elements form the branches (non-terminal nodes). Elements that are not defined in terms of other elements form the leaves (terminal symbols) and may be referred to as tokens. From this grammar, a tool may be created that takes specific actions when specific terminals (tokens) are encountered. Because the grammar defines the syntax it is necessarily closely tied to the source syntax. For example, the following is a context free grammar for translating addition and subtraction from standard notation into conventional post-fix notation (non-terminals are in italic):

expression-> term therest

therest->+term|−term rest|empty

term-> number

This grammar translates a context-sensitive expression such as 24−3+15 into the context-free post-fix expression 24 3−15+.

The “un-nested” context-free grammar thus may be used to represent an internal representation that is more convenient to process. This internal representation may then be used to generate a sequence of commands in the target format.

Conventional file format translators are generally based upon this compiler-like approach of translating commands in the source format to commands in the target format. Such an exhaustive, formal analysis, however, tends to be more appropriate for a compiler or interpreter, where every single command must be converted into the proper sequence of CPU instructions. Because the files (e.g., formatted text documents) translated by a file translator have a different structure than programs (e.g., executable files) translated by a compiler or interpreter, a file format translation program must take a different approach.

For example, executable programs are composed of commands and variables or memory and register accesses. Commands tell the computer to do something and variables tell the computer where to access information. Documents, on the other hand, are better characterized as a series of features rather than a series of commands. Where commands manipulate variables, features contain static data. Where variables tell a program how to find data, the feature itself tells a document how to find data.

Moreover, in a program, a variable may contain the location of data rather than contain the data itself (usually referred to as a pointer). In some cases a variable may be a pointer to a pointer. In a document, on the other hand, the data is often composed of features which each contain data. That data then is often composed of more features, and so on. For instance, the main text flow feature of a text document contains paragraph features. Each paragraph feature contains text features. Each text feature contains the text itself. Moreover, many potential target formats explicitly store documents as tree structures. In these formats all commands either come in pairs (a beginning command and an end command) or have a beginning and an end with data stored between the beginning and end.

For example, XML commands either take the form:

<command>Data</command> or take the form <command Attribute_Data>.

In the first form, Data can be simple text or more commands. In the second form, Attribute_Data is numeric, string, or other simple data that follows formatting conventions specified for that flavor of XML. The Adobe® FrameMaker® MIF format (Adobe Systems Incorporated, San Jose, Calif. 95110-2704) also has a tree structure that takes the form <command Data>. In MIF Data can be numeric, string, or a command.

Thus, a need exists for an improved file format translator that addresses drawbacks associated with the prior art.

### SUMMARY

According to an embodiment of this invention, a translator is provided for translating a source file in a source format to a target file in a target format. The translator includes a feature identifier to determine a feature set of the source file, and a feature writer to write the feature set into the target file in the target format.

In optional variations of this embodiment, the feature identifier includes a front-end lookup table to map code fragments of the source file to a list of features. The feature writer may include a back-end lookup table to map the feature set to code fragments of the target file format.

In another embodiment of the present invention, a method is provided for translating a file from a source format to a target format. The method includes identifying a feature set of a source file, and writing the feature set into a target file in the target format.

In a further embodiment, a method is provided for configuring a system to translate a source file in a source format to a target file in a target format. The method includes providing a feature identifier to determine a feature set of the source file, and providing a feature writer to write the feature set into the target file in the target format.

A still further embodiment includes a system for translating a source file in a source format to a target file in a target format. The system includes a feature identifier to determine a feature set of the source file, and a feature writer to write the feature set into the target file in the target format. Another embodiment includes an article of manufacture for translating a source file in a source format to a target file in a target format. The article of manufacture includes a computer usable medium having a computer readable program code embodied therein. The computer usable medium includes computer readable program code for identifying a feature set of the source file, and computer readable program code for writing the feature set into the target file in the target format.

Another embodiment of the present invention includes computer readable program code for translating a source file in a source format to a target file in a target format. The computer readable program code includes computer readable program code for identifying a feature set of the source file, and computer readable program code for writing the feature set into the target file in the target format.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1 is a block diagrammatic view, with optional portions shown in phantom, of an embodiment of the present invention;

FIG. 2 is a block diagrammatic view, with optional portions shown in phantom, of an alternate embodiment of the present invention; and

FIG. 3 is a block diagrammatic view, with optional portions shown in phantom, of elements of the embodiments of FIGS. 1 and 2.

### DETAILED DESCRIPTION

Referring to the figures set forth in the accompanying Drawings, the illustrative embodiments of the present invention will be described in detail hereinbelow. For clarity of exposition, like features shown in the accompanying Drawings shall be indicated with like reference numerals and similar features as shown in alternate embodiments in the Drawings shall be indicated with similar reference numerals.

Briefly described, embodiments of the present invention permit a user to effect translations between files of significantly distinct formats. These embodiments use discrete lookup tables for the back-end of the translation, to advantageously facilitate writing a wide variety of formats. These embodiments collect data by finding feature parts of a source file, (rather than individual instructions) followed by assembling these feature parts, and then writing the collected data in a tree-structure format.

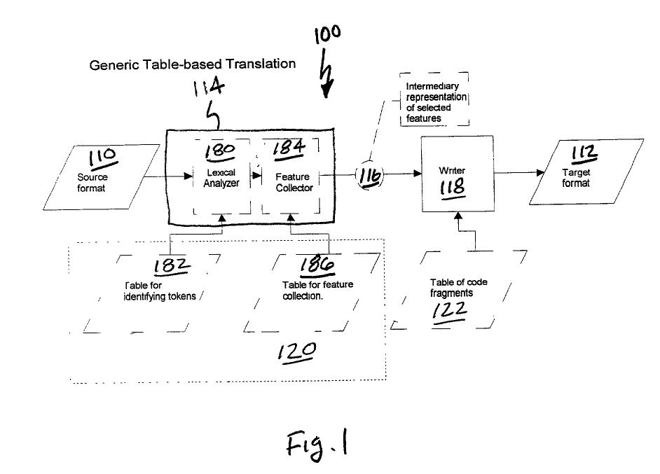

Referring now to FIGS. 1-3, the embodiments of the present invention will be more thoroughly described. Turning now to FIG. 1, an embodiment of the present invention is shown as generic file format translator 100. This translator is capable of translating source file formats (interchangeably referred to herein as source files) 110 to other (target) file formats (interchangeably referred to herein as target files) 112 having mutually distinct internal structures, but similar features and levels of abstraction. For example, in a particular implementation, translator 100 may translate FrameMaker®) source files 110 to WINHELP® (Microsoft Corporation, Redmond, Wash.) target files 112, or to HTML on-line help files. Additional options include translation between graphic file formats, spreadsheet file formats, or between executable file formats. Translator 100 effects such translation without re-compiling the source file or program.

Instead of translating commands in the source format 110 to commands in the target format 112, embodiments of the present invention use a feature identifier 114 to identify a set of features in the source file 110 that will be translated. As used herein, a feature may include a paragraph style, straddled cells in a table, cross-referencing, pen styles in a drawing, etc. Additional features may include other document formatting, document header specifications, document footer specifications, discontinuity indicators, order indicators, location indicators, beginning indicators, ending indicators, data types, data translation pairs, document macros, implied features, implied feature endings, and combinations thereof. As translator 100 reads through the source file 110 it collects information about the features. Unlike conventional translators or compilers that look for and translate on an individual command-by-command basis, the translator 100 identifies features that may be represented by a command, a parameter of a command, or multiple commands spread throughout the source file 110. These feature representations are variously referred to herein as tags. Translator 100 may assemble the description of the features read by identifier 114 as an intermediary representation, stored in any convenient manner such as in a buffer or RAM (random access memory). This intermediary representation and the storage media (e.g., buffer) in which it is stored, are interchangeably referred to herein as intermediary representation or buffer 116, 216. When the translator 100 has read a complete description of the features of source file 110 and completely assembled the representation 116, translator 100 may use writer 118 to write a series of commands (also referred to herein as code fragments) that describes each of the identified features, to produce the target file 112.

Thus, rather than being syntax-directed, embodiments of the present invention are feature directed. Being feature directed, translator 100 is less closely tied to any particular file format than syntax-directed translations, and is thus relatively generic.

Translator 100 may optionally use tables at the front end and/or the back end to associate features with various code fragments or tags. For example, as shown in phantom, feature identifier 114 may optionally include a front-end table (also referred to as a front-end tag file) 120 in the form of a lookup table that includes specific tags associated with individual features in source format 110. Similarly, writer 118 may include a back-end table (also referred to herein as a back-end tag file) 122 in the form of a lookup table that includes specific tags associated with individual features in the target format 112. In operation, the writer 118 functions similarly, though in reverse, to the identifier 114, querying the intermediary representation 116 for the next feature, looking that feature up in the table of code fragments (tag file) 122, and then writing the corresponding sequence of code fragments required to produce the particular feature. Translator 100 thus may include both a table-based front-end and a table based back-end. In light of the foregoing, as used herein, the term “tag file” shall be used to interchangeably refer to look-up tables disposed either in the front-end, such as table 120, or in the back-end, such as table 122.

The lookup tables associate each feature to a code fragment (tag) beginning and a code fragment (tag) end. In lookup table 122, each feature may either be mapped to a single command in the target language, or to a sequence of commands with no associated data plus a single command with data. For example, when the file writer 118 encounters the beginning of a feature (i.e., in the intermediary representation 116) it looks the feature up in lookup table 122 and writes the corresponding beginning code fragment (tag). When the file writer 118 encounters data, it writes the data directly to the target file 112. When the file writer 118 encounters the end of a feature, it looks the feature up again in table 122 and writes the corresponding end code fragment.

This method of separating beginning code fragments (tags) from end code fragments (tags) permits translator 100 to easily translate to conventional tree-structured file formats, such as MIF or XML. This ability is in contrast to conventional code generation tables typically found in compilers, which tend to only allow generation of sequentially structured formats.

Moreover, in the event a target file format is not a tree structure, it may still be written as if it were. In general, non-tree file formats will represent features as one or more commands followed by data, or data followed by one or more commands, or a command containing data. In the first instance, the commands may form the “beginning code fragment” of the tree structure, and the “end code fragment” may simply be empty. In the second case the “beginning code fragment” of the tree structure may be empty, with the commands located in the “end code fragment”. In the final case the beginning of the command may be located within the “beginning code fragment” and the end of the command may be located within the “end code fragment”.

Programs which save files in a tree structured language like XML usually do not use a lookup table to handle writing because these programs typically are designed to write one flavor of XML or one particular file format (so a lookup table is unnecessary). Even programs that may use a lookup table (such as the FrameMaker® HTML writer, and Quadralay® Webworks™, (Quadralay Corporation, Austin, Tex.), the programs do not use a feature-based reader. This means the output is limited to slightly different interpretations of the same output format or to closely related flavors of a generalized format like XML. Embodiments of the present invention thus advantageously use a feature-based reader which allows it to use a back-end lookup table 122 that is flexible enough to write nominally distinct tree structured formats, sequential formats, post-fix formats and other discrete file format structures.

As a further alternative shown in phantom, while using the aforementioned feature-based back-end writer 118, feature analyzer 114 and front-end table 120 may include a two-step system including a lexical analyzer 180 coupled to a table 182 for identifying tokens within the source file 110, and a feature collector 184 coupled to a feature collection table 186 for associating features with the tokens.

Having described an embodiment of the present invention, operation of embodiments of the present invention is now discussed.

In a general implementation of translator 100, a file is created in the source format 110. Translator 100 reads the source file 110 with analyzer 114 using look-up table 120 to interpret commands associated with translatable features. Commands not associated with translatable features are ignored. When translator 100 has assembled a complete description of the features (and optionally stored the features in intermediary representation 116), writer 118 looks the features up in the back-end lookup table (tag file) 122. A section of this table 122 indicates where the program can write each of the features in the target file 112. Other sections of table 122 may specify how the feature should be written. Intermediary representation 116 may serve as a convenient buffer to retain feature information while subsequent features are analyzed, such as in the event the sequence of features needs to be re-organized before writing to the target format 112. When the writer 118 is ready to write a feature, it does the following:

1. Takes the beginning code fragment (tag) from the tag file 122, and writes the tag to the target file 112.

2. Takes the data and performs any manipulations specified in the tag file 122, then writes the data to the target file 112. These manipulations are generally relatively simple unit conversions, such as integer to ASCII or inches to centimeters, etc.

3. Takes the ending code fragment (tag) from the tag file 122, and writes the tag to the target file 112.

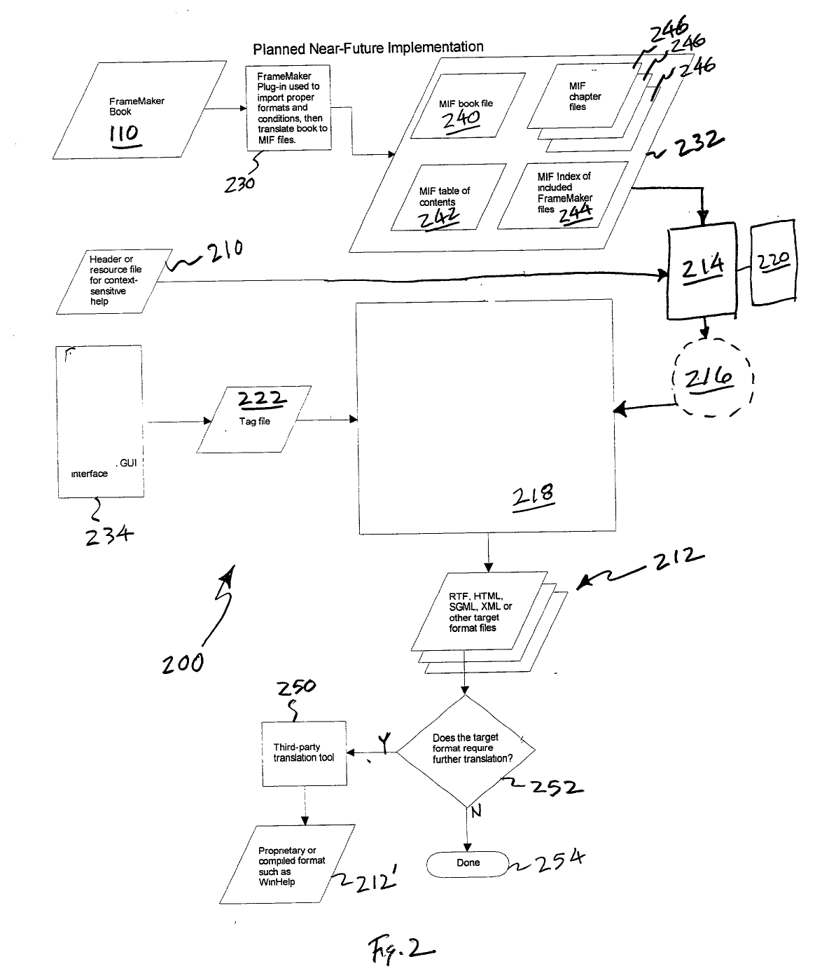

In addition, translator 100 may include one or more sample front end or back end tag files 120, 122 for particular formats. Users may take these sample tag files and modify them for their own customized applications. In a particular embodiment, such tag file modifications may be effected through a conventional Graphical User Interface (GUI) 234, such as shown in FIG. 2.

Turning now to FIG. 2, a more detailed embodiment of the present invention is shown as translator 200. In a typical embodiment of the present invention, the translator 200 may need to read multiple files with different source formats 110. To facilitate this, a plug-in 230 to the file-generator program (i.e., the program that creates the file 110) may be used to help prepare the file 110 for translation. For example, a conventional on-line help system generally requires a table of contents. A conventional plug-in for the FrameMaker® program is generally used to execute a sequence of steps necessary to generate the table of contents in the FrameMaker® book file 110. A similar plug-in 230 may invoke translator 200 to handle the actual translation from a FrameMaker® book file 110 to FrameMaker® MIF files 232. For example, as shown, MIF files 232 may include one or more MIF book files 240, MIF table of contents files 242, MIF index files 244, and MIF chapter files 246. These MIF files may then be analyzed as discussed hereinabove by analyzer 214.

In addition to MIF files 232, analyzer 214 may analyze C/C++ header files 210, such as may be desired to translate files in a conventional context-sensitive Help system. For example, if the target file 212 is a form in a conventional context-sensitive Help system, then analyzer 214, in combination with front-end table 220, may read C/C++ header files (or JAVA resource files) 210 associated therewith, to determine the conventional topic Ids of the context-sensitive topics. Analyzer 214 and table 220 may also derive any dynamic elements of the source file 110 such as table of contents, and index entries, which may be subsequently used by writer 218 and tag file 222 to generate corresponding features, such as a Contents Dialog and Keyword Index for WINHELP® (Microsoft® Corporation) Help files.

Additional file formats that may be read by translator 200 include, for example, WMF (Windows Metafile Format) files, which may be translated into SVG (Standardized Vector Graphic) or Flash™ files (Flash™ is an open format published by Macromedia Inc., San Francisco, Calif.), to enable vector graphics to be used in HTML based help files. Any front-end add-ons or plug-ins 230 may optionally be enabled to read two or more source formats.

In the event the desired target format is a public or open format such as HTML, RTF, SVG, or Flash, the process may be complete 254 once the writer 218 generates the target file 212. Alternatively, the translator 200 may determine 252 whether the target format 212 requires further translation. For example, in the event the desired target format is non-public, (such as the WinHelp® format) additional translation may be required to convert the public target file 212 into the desired (non-public) final format 212′. To accomplish this additional translation, a tool 250, such as may be provided by or on behalf of the owner of the non-public target format, may be used to convert the public format 212 into the non-public format 212′. In the example shown, the MIF files 232 may be translated to RTF files at 212. A Help Compiler available from Microsoft® may then be used at 250 to convert the RTF to the non-public WinHelp® format. Moreover, in addition to RTF files, the target 212 may include files in the HPJ (Help Project File) format to provide instructions to the Help Compiler.

Additional file formats that may be translated (i.e., that may serve as either source or target formats) include WordPerfect® (Corel Corporation, Ottawa, Ontario, Canada), Corel® VENTURA™ (Corel Corporation) Microsoft® Word, BroadVision® Interleaf (Redwood City, Calif.), HTML, SGML, XML, C, C++, Visual Basic® (Microsoft®), Pascal, Java™ (Sun® Microsystems, Inc., Palo Alto, Calif.), MFC, MetroWerks® PowerPlant, Swing™ (the Sun® development framework for Java), SVG, HPJ, Flash, Microsoft® WMF (Windows Meta File), VRML (Virtual Reality Markup Language), Pixar® RenderMan® file formats (procedural, shader, and RIB), (Pixar Animation Studios, Richmond, Calif.), Apple® 3DMF (3D MetaFile) (Apple Computer, Inc., Cupertino, Calif.). The skilled artisan will recognize that substantially any file format now known, or developed in the future, may be translated by embodiments disclosed herein, without departing from the spirit and scope of the present invention.

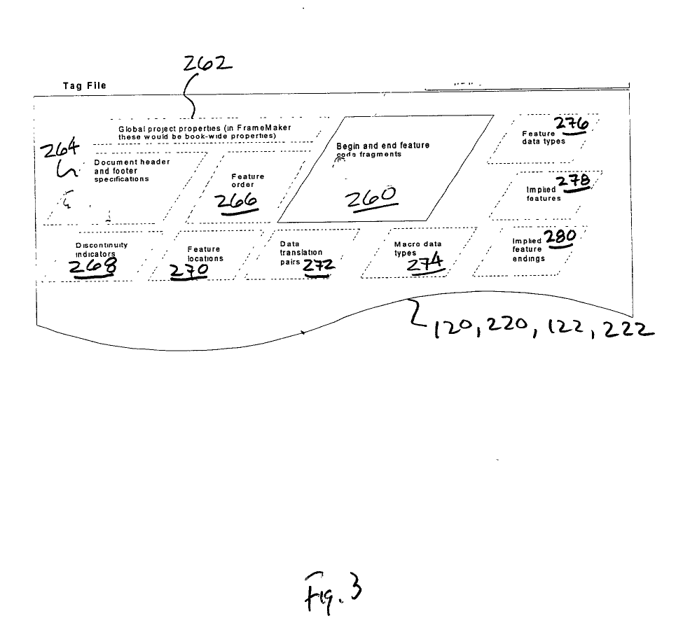

Turning now to FIG. 3, various aspects of tag files 120, 220, 122, 222, are described in greater detail. Examples of portions of these tag files are shown hereinbelow with respect to embodiments associating features with tags in the ASCII format. The skilled artisan will recognize that alternate embodiments may associate features with tags in substantially any format, such as RTF, HTML, SGML, XML, other SGML-like formats, and any other format mentioned herein, etc., without departing from the spirit and scope of the present invention. As shown, various features or components of features identified in an exemplary tag file include begin and end code fragments 260, Global Project Properties (such as Book-wide Properties in FrameMaker®) 262, document Header and Footer specifications 264, the order of features 266, discontinuity indicators 268, feature locations 270, data translation pairs 272, macro data types 274, feature data types 276, implied features 278, and implied feature endings 280. Additional features may also be included. As discussed hereinabove, the tag file 122, 222, describes how to write features in the target format from the features identified by analyzer 114, 214 (and optionally assembled in the intermediary representation 116, 216). Similarly, tag file 120, 220, describes how to create the intermediary representation 116, 216 from the original source 110, 210. Some aspects of the tag file shown in FIG. 3 serve to help the translator 100, 200 determine whether it has collected/written a complete feature.

Exemplary coding format and/or examples of various aspects of tag file 120, 220, 122, 222, shown and described with respect to FIG. 3 are set forth hereinbelow in conjunction with Appendix A. It is to be understood that these examples should not be construed as limiting.

An exemplary format for tag files 120, 220, 122, 222, is generally simple so that it is relatively easy to parse. For instance, Comments may start with #. Features may be divided into categories. Categories may be introduced with a header surrounded by square braces [ ]. Each block set forth in FIG. 3 and discussed hereinabove may be introduced with a header surrounded by curly braces { }. Each feature category in the code fragment section may then be introduced with a header surrounded by square braces. Features may be named with keywords that start at the beginning of a line and are followed by an equal sign (=). Spaces may not allowed before the equal sign unless they are part of the keyword. Fields on the right side of the equal sign are separated with a semi-colon (;). If the target format uses semi-colons, then they are replaced with the string %semi%. Any line beginning with Text=is a quoted line. The category in which this line occurs determines how the text after the equal sign is used. A brief example of some aspects of this coding format is shown as Example 1 in Appendix A hereof.

Global Project Properties 262, for example, may be written to a project file. In a document translation, global properties 262 include things such as a list of document files in the translated book, paths to included graphics, and the title on a resulting help system display. WinHelp® translations may require a help project file with the extension HPJ, while HTML Help may not require a project file. If the tag file 122, 222, defines a translation to Winhelp® it may have a section header: [projectFile=hpj]. If the target format is a different system that required a project file with a different extension, such as prj, then the section header may be: [projectFile=prj]. After the section header a series of “Text” keywords may specify the contents of the project file. For instance, Text=OLDKEYPHRASE=NO, indicates that the line “OLDKEYPHRASE=NO” should be included in the project file. Alternately, the file extension may be removed from the header and placed in an “extension” feature in the {projectFile} section. In the MIF to RTF translation the projectfile section specifies the resulting help project (HPJ) file. Portions of the file that remain constant from translation to translation may be specified as literal strings. Portions that change may be specified as variables. Variable identifiers may be plain-text strings quoted with percent signs on either side. For example %contentsTopic% is a variable. Although embodiments of the present invention may use variables, their use is discouraged because they may make the translation less generic. Rather specific embodiments of the present invention may replace all variables with features that have beginning and end code fragment pairs.

Text that replaces a variable may be generated from information gathered from the source (e.g., FrameMaker®) book file and information gathered while reading the FrameMaker® document files. The translation may not finish writing the HPJ file until the last document has been read. For instance, Text=%FileList%, indicates that a list of files derived from the FrameMaker® index of references should be included in the project file. As the translator 100, 200 reads the FrameMaker® document, it constructs a list of files. After the last document is read, the translator writes the HPJ file. When it encounters the %FileList% variable, it dumps the collected list to the HPJ file. An exemplary RTF Tag File is shown as Example 2 in Appendix A. An exemplary portion of an HPJ (Help ProJect file) file is shown as Example 3 in Appendix A.

Exemplary Document Header and Footer Specifications 264 are now discussed. Most file formats tend to have a header or footer containing document-wide parameters. Unlike project files, which generally apply to a group of files, headers and footers generally apply to a single file. Some file formats also have a footer with other document-wide parameters. Like project properties, the bulk of the header or footer is specified as literal text. The parts that change from document to document or from translation to translation may be specified as variables. Usually the header, body, and footer are written sequentially with the header first. If some of the information written to the header is not found until the entire document file has been read, then the tag file may specify that the header is written last. After all three components (header, footer, text) have been written (e.g., by writer 118, 218) or buffered, the translator 100, 200, may re-assemble them in the correct order in the target file 112, 212, 212. An example of Document Header and Footer Specification 264 is shown as Example 4 in Appendix A.

Feature Order 266 is now described. In some file formats features must be written in a specific order relative to one another. If order is important in any of the target formats, the required order may be specified in the tag file. In an exemplary HTML Tag File, the following entry in the {featureOrder} section specifies that a jumpLink feature is composed of a jumpID feature followed by a jumpText feature.

jumpLink=%$jumpID$$jumpText$%

In an exemplary RTF Tag File, the following entry in the {featureOrder} section specifies that a jumpLink feature is composed of a jumpText feature followed by a jumpID feature.

jumpLink=%$jumpText$$jumpID$%

If a target format required the ID to be placed after the jumpText, but before the end jumpText code fragment, the specification may be:

jumpLink=%$jumpText$<DATA><$jumpID$>%

Tag file items that specify the beginning and ending 260 of a feature may be code fragments. It is up to the user who writes the tag file 120, 122, 220, 222, or the GUI 234 that builds the tag file to create fragments that conform to the target format syntax. The translator 100, 200 may paste these code fragments together with data from the source file 110, 210, building up the target file 112, 212, 212′, like a patchwork quilt.

Other sections of tag file 120, 220, 122, 222, are optional. When a user is expected to specify collections of features with a style in the source format, each style may be treated as a separate feature in the tag file. For example, FrameMaker® has paragraph styles, character styles, and table styles. Each paragraph style defines spacing, fonts, alignment, and other features. A tag file that translates MIF to RTF should treat each paragraph style as a separate feature. Likewise, each character and table style should be a separate feature.

For instance, the tag file might specify that the MIF character style “strong” gets translated to the RTF character style “cs7” which has the format 12 pt Ariel bold-italic. The beginning fragment then switches to 12 pt Ariel bold-italic text. The end fragment switches back to the default text format.

FrameMaker®, RTF and HTML share the concept of paragraph style tags. If the tag file defines a translation to RTF (which is then translated to Winhelp), or HTML, then there is a [pgfTags] section. This [pgfTags] may be treated as a category of {codeFragments}. Each feature in this section may be the name of a paragraph style tag. After the equal sign several fields are specified, separated by semicolons (;). Each field after the third may be optional. The first two fields specify how to start a paragraph of the indicated style. (The first field goes at the beginning of a table row if the paragraph is part of a table. The second field goes inside a table cell if the paragraph is part of a table.) The third field specifies how to end the paragraph style. If the fourth field exists, and is not blank, it indicates whether the paragraph begins a new topic or TOC entry. This field also specifies the level of the heading so the TOC can be automatically reorganized if necessary. The fourth field may be moved to a different section. For example:

paragraphStyle=%$paragraph$<$defaultFont$><DATA>%

The following specifies a Heading 1 style tag for an RTF target file:

Heading 1=\s430\sa120\sb50\keepn\widctlpar;\cf13 \b\f5\fs28\kerning28 ; ;Y4

The resulting RTF when some Heading 1 text reads “This is the Heading 1 Text” would be:

s430\sa120\sb50\keepn\widctlpar\cf13 \b\f5\fs28\kerning28 This is the Heading 1 Text

If the target file is HTML, then the specification for the same style tag may look like the following line:

Heading 1=<H1>; ;</H1>;Y4

The resulting HTML would be:

<H1>This is the Heading 1 Text</H1>

Feature Data Types 276 are now discussed. During translation the data of a feature may be placed between the beginning and end code fragment. In a document format like MIF, RTF, or HTML, data is usually text that gets printed in the final document. The data can also be a number, file name, data tree, or other miscellaneous data.

If the data needs to be rearranged or translated for inclusion in one of the file formats, the target data format or type needs to be specified in the tag file. For instance, if the data is binary, byte order and data size may have to be specified. If the data is a measurement, the unit of measure may have to be specified. The translation program then converts the data to the proper format. There may be a plug-in or scriptable architecture to provide data reformatting and translation beyond the built-in capabilities.

Graphics may be external files, so the position of a graphic is indicated by a different feature than the data in a graphic. There are multiple graphic formats, each indicated by a different feature. A graphic feature group may be defined in the {dataType} section as follows:

graphic=[$bitmap$;$vector$;$photo$]

In the {featureLocation} section discussed below, the graphic feature group is also defined. In that section there are different features listed in the feature group definition. This associates the graphic formats in the {dataType} section with the graphic location features in the {featureLocation} section. In the HTML tag file the bitmap format is specified as follows:

bitmap=gif

In the RTF tag file the bitmap format is:

bitmap=bmp

Like features, feature locations 270 also have data types 276. Since grouping is used to link features to their corresponding locations, the group can be used to specify the feature location data type. In both the HTML and RTF tag files feature location data type may be specified as follows:

graphic=%windowsFilePath%

In some instances certain content in the source file has meaning that should be provided to a target file feature. For instance, in the MIF files written for on-line help by Wind River® Systems, Inc. (Alameda, Calif.), the writers used a particular character tag to indicate a hypertext jump. If a different template were used to generate on-line help, a different character tag would be used for the same feature. The tag file must indicate to the translation program how to identify these user specific features. These are referred to as implied features 278. Implied feature definitions are changed when the user changes the way the source file is used. These features are not necessarily changed when the target format changes. In one example, if a linkJump font tag feature is encountered, a jumpLink feature sequence is implied. The data in the linkJump font tag becomes the data in the jumpText feature that is contained within a jumpLink feature sequence.

[impliedFeatures]

jumpText=[featureOrder]linkjump[fntTags]

When the translator encounters a linkjump font style, it finds jumpText in featureOrder, and sees that jumpText is part of a jumpLink feature sequence. The other part of the sequence is jumpID. If the translator front-end has both parts, it sends a jumpLink feature to the back-end. The back-end then generates and start code for the jumpLink feature, then writes the jumpText and jumpID features in the correct order. When the back-end writes the jumpText feature it generates start code for that feature, then generates start code for the linkJump font feature, then writes the text data, then writes the end code for both features.

Discontinuity Indicators 268 are now described. Some features in the source file can disrupt the sequential organization of the main body in the target format. This discontinuity either redirects the main body to another position within the same file, or redirects the main body to a different file. For example, each topic in an HTML-based help system like JavaHelp® is contained in a new file. The “new topic” feature redirects the main body to a new file. This new topic feature is implied by heading character tag features. The redirect type and the feature that signals redirection should be indicated in the tag file. For example, the newTopic feature is implied by various heading paragraph tags. This is defined in the {impliedFeatures} section:

newTopic=[redirect]{$ChName$[pgfTags];$H2$[pgfTags];$H3$[pgfTags]}

The {redirect} section then indicates that newTopic features start a new file:

newTopic=NEWFILE

When a ChName, H2, or H3 paragraph is encountered, the translation will use the definitions in other sections to write a newTopic feature (The newTopic feature is usually written as a link to the next topic. This link is usually placed at the top and bottom of the current topic.) Once the newTopic feature is written, the translator will start a new file (with a name based on the paragraph data), then after the file header place the paragraph which triggered the new file.

With regard to feature Locations 270, a feature can be written in the main file header, in a separate file, in the main body of the file, or after the main body of the file. If the tag file specifies that the feature is written somewhere other than the main file body, the tag file may also specify how the target format associates the feature data with the location. For instance, in a MIF file tables are written before the main text flow of the document. Each table has an ID which is used to indicate where the table is in the main text flow. If a tag file were created to write MIF files, it would need to specify how the ID is written in the table, and how the ID is written in the main text flow. The tag file would also need to specify that the table gets written before the main text flow, rather than within the flow as it is with RTF or HTML files. Graphics are typically external files imported into the target format by reference. Graphics may be specified in the {featureLocations} section as follows:

graphic={$graphicLeft;graphicRight;graphicCharacter$}graphic=EXTERNAL

The first line indicates the location features that are graphic locations. The second line indicates that the data for a graphic is placed in an external file. The name of the external file is specified by the location data. If a file name is not specified, one is generated.

Data Translation Pairs 272 are now discussed. In document formats there are usually special characters that either need to be escaped in the source or target text. The existence of escaped characters needs to be indicated in the tag file, and the translation from source character to target character needs to be specified as a data translation pair in the tag file. There are no field indicators, macro indicators, or group indicators in a pair specification. If an equal sign needs to be used in the source specification of the pair, this may be indicated as %EQUAL%. For example, the following replaces FrameMaker® codes for an ampersand, less than, and greater than with the corresponding HTML code. In this section all punctuation is read literally.

[replacePairs]

&=&amp;

<=&lt;

\>=&gt;

The locations of feature parameters sometimes may be indicated within the beginning and end code fragments as variables. That is, there is a place-holder in the code fragment that indicates “this parameter goes here”. Like other instances of variables, this is a convenience that can be avoided with proper selection of features. The parameter can be something read directly from the source format, or can be derived from data in the source format. The parameter can be a single item, a list of items, or more structured data like a data tree. The units and data types of the target parameters are specified in the tag file. The translation program then has utilities that convert the source parameters to the target units and data types. These unit and data type conversion utilities should also be extensible through plug-ins or scripting.

Generally a single feature can be broken into multiple feature definitions in the tag file to avoid using variables and to make the tag file easier to read and debug. For instance, MIF, and HTML each have a feature to imbed a bitmap in text. This feature has a parameter that specifies the position of the graphic relative to its location in the text stream. Instead of defining one bitmap feature with a location parameter specified as a macro in the tag file, the tag file defines multiple bitmap features, each with a different location (e.g. graphicLeft, graphicCharacter, graphicRight, graphicRunIn, etc.)

In a file that specifies an HTML target, the positioning of a graphic could be defined as a variable. In this case, the code fragment specification for a graphic may be:

graphic=<IMG ALIGN=“%Alignment%” SRC=“;>

To avoid using a variable, the graphic feature is split into three different features. The syntax used to write a left justified graphic may then specified as follows:

graphicLeft=<IMG ALIGN=“LEFT” SRC=“;”>

For the bitmap agraphic.bmp, the resulting HTML would be:

<IMG ALIGN=“LEFT” SRC=“agraphic.bmp”>

In the RTF specification, the same feature may be specified as follows:

graphicLeft=\{bml ;\}

For the bitmap “agraphic.bmp” the resulting RTF would be:

\{bml agraphic.bmp\}

In both formats the feature data type is defined (in the {dataType} section) as:

graphicLeft=%windowsFilePath%

Implied feature endings 280 are now discussed. In some instances the source format does not clearly indicate where a feature ends. For instance, in FrameMaker there is generally no way to indicate the end of a numbered or bulleted list. The list is assumed to end whenever one of a collection of styles is encountered. Typically this includes the paragraph tags “Body”, “Heading 1”, “Heading 2”, “Heading 3”, etc. The tag file must indicate feature endings that are implied, and must list the features which signal the feature ending.

In HTML a numbered list begins with a <ol>. Each item in the list begins with a <li> and ends with a </li>. The numbered list then ends with a </ol>. In FrameMaker a numbered list begins with a paragraph tag like NumberedFirst. This paragraph begins the first item in the list. The first item ends with the beginning of the next item. The next item begins with a paragraph tag like Numbered. The list ends when a normal paragraph like Body, H2, H3, H4 etc. is encountered. This structure has two implied feature beginnings and two implied feature endings. The implied beginnings are defined in the {impliedFeatures} section.

numList=NumberedFirst

numItem={$NumberedFirst$;$Numbered$}

The implied feature endings are then defined in the {featureEnd} section.

numList={$Body$;$Ch#$;$H2$;$H3$;$H4$;$HU$;$HU-Run$;$TaskIntro$}

numItem={$Numbered$;$Body$;$Ch#$;$H2$;$H3$;$H4$;$HU$;$HU-Run$;$TaskIntro$}

The numList and numitem features are then defined in the code fragments section.

numList=<ol>; ;</ol>

numItem=<li>; ;</li>

An additional exemplary tag file useful as a front-end file 120, 220, is also included as Example 5 of Appendix A. As discussed herein,

Embodiments of the foregoing invention may advantageously be used to translate text formats, graphic formats, debugging information formats, GUI framework source code, or nominally any other file format. As a particular example, these embodiments may be useful for producing Wind River® SingleStep® on-line documentation. The embodiments may also be useful as a tool for producing Wind River® Tornado™ on-line documentation and may be useful as a tool to produce documents for other on-line help systems, such as on-line help displayed with the Wind River® ICEBrowser™. Other implementations of embodiments of the present invention may be used in substantially any situation in which translation from one or two source formats to a wide variety of target formats is desired. Examples of such applications include: document publishing, page layout, vector graphics, 3D graphics, word processors, spreadsheets, and databases. One implementation that may be of particular interest is as a programming framework translation tool. Such an implementation may read MFC (Microsoft® Foundation Class) files (resource, header, C, and C++ files), then translate code for GUI features and other high-level features to code for corresponding features in other frameworks that compile to other targets, such as UNIX, Macintosh™ (Apple Computer Inc.), Palm (Palm, Inc. Santa Clara, Calif.), other handhelds and displays, etc. Such embodiments of the present invention may be advantageously used by programmers skilled in conventional (i.e., non-embedded) programming for embedded system programming. Additional uses for embodiments of the present invention include translation of executable formats such as ELF/DWARF to other formats such as the SDS SingleStep object file format. If such a translation were effected, it may then be used to translate to new formats as they are introduced. For instance, if one were to develop a binary XML-like executable format, embodiments of the present invention may be used to quickly develop a translation from ELF/DWARF to that new format.

Although embodiments of the present invention have been described that include both front-end and back-end lookup tables, the skilled artisan should recognize that substantially any file translator having a back-end lookup table, regardless of whether or not a front-end lookup table is used, should be considered to be within the spirit and scope of the present invention. For example, a file translator having a front-end lexical analyzer and/or parser such as described hereinabove with respect to the LEX and YACC languages, while using a back-end lookup table as set forth hereinabove, is within the spirit and scope of the present invention.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense.

Having thus described the invention,

APPENDIX A
Example 1
# comment
#
[Tag File Category 1]
Feature_1=Feature1_Rules
Feature_2=Feature2_Rules
. . .
[Tag File Category 2]
. . .
[Code Fragment Category 1]
Feature_1=Beginning Code Fragment_1;End Code Fragment_1
Feature_2=Beginning Code Fragment_1;End Code Fragment_1
. . .
[Code Fragment Category 2]
. . .
[Tag File Category n]
. . .
Example 2
[projectFile=hpj]
Text=;Help Project File generated from FrameMaker MIF
Text=;Conversion program mifcvrt written by Mark Stevens
Text=;Copyright (C)1997-2000 Wind River Systems, Inc.
Text=[Options]
Text=NOTES=0
Text=Title=%curWndName%
Text=CONTENTS=%contentsTopic%
Text=CITATION=(c)1997-2000 Wind River Systems, Inc.
Text=COPYRIGHT=Help text copyright 1997-2000 Wind River Systems, Inc.
SingleStep Help System designed by Mark Stevens. Written by Mark Stevens,
Ananda Stevens, and Don Richie. Authored with Adobe FrameMaker.
Text=OLDKEYPHRASE=NO
Text=OPTCDROM=0
Text=REPORT=NO
Text=COMPRESS =12
Text=ERRORLOG=eror.txt
Text=BMROOT=Art
Text=BMROOT=. . \Art
Text=[FILES]
Text=%FileList%
FileListSyntax=%File%
Text=[ALIAS]
Text=#include <GUIAlias.hh>
Text=%AliasList%
AliasListSyntax=%Alias%=%Target%
Example 3
;Help Project File generated from FrameMaker MIF
;Conversion program mifcvrt written by Mark Stevens
;Copyright (C)1997-2000 Wind River Systems, Inc.
[Options]
NOTES=0
Title=Contents
CONTENTS=IDH_sngppctoc_Contents
CITATION=(c)1997-2000 Wind River Systems, Inc.
COPYRIGHT=Help text copyright 1997-2000 Wind River Systems, Inc.
SingleStep Help System designed by Mark Stevens. Written by Mark Stevens,
Ananda Stevens, and Don Richie. Authored with Adobe FrameMaker.
OLDKEYPHRASE=NO
OPTCDROM=0
REPORT=NO
COMPRESS=12
ERRORLOG=error.txt
BMROOT=Art
BMROOT=. . \Art
[FILES]
r:\pub\SingleStep\sngppcTOC.rtf
r:\pub\SingleStep\UserGuide\overview.rtf
r:\pub\SingleStep\UserGuide\conventionsoverview.rtf
r:\pub\SingleStep\UserGuide\introducton.rtf
r:\pub\SingleStep\connections\help\connectionsoverview.rtf
r:\pub\SingleStep\connections\tornado.rtf
r:\pub\Sing1eStep\connections\embeddeddesktop.rtf
r:\pub\SingleStep\connections\psos.rtf
r:\pub\SingleStep\connections\help\advancedsimulator.rtf
[ALIAS]
#include <GUIAlias.hh>
IDF_menustoolbarspopups_72354=IDH_menustoolbarspopups_Source_Pane_Popup
_Menu
. . .
Example 4
{headerFooter}
[header]
Text<html>
Text<body bgcolor=“#ffffff”>

Beginning of Each Resulting HTML File

<html>

<body bgcolor=“#ffffff”>
Example 5
#
# Tag File
# Governs translation of MIF to RTF
# Used with miftortf4
[projectFile=hpj]
Text=;Help Project File generated from FrameMaker MIF
Text;Conversion program mifcvrt written by Mark Stevens
Text=;Copyright (C)1997-2000 Wind River Systems, Inc.
Text=[Options]
Text=NOTES=0
Text=Title=%curWndName%
Text=CONTENTS=%contentsTopic%
Text=CITATION=(c)1997-2000 Wind River Systems, Inc.
Text=COPYRIGHT=Help text copyright 1997-2000 Wind River Systems, Inc.
SingleStep Help System designed by Mark Stevens. Written by Mark Stevens, and
Ananda Stevens. Authored with Adobe FrameMaker.
Text=OLDKEYPHRASE=NO
Text=OPTCDROM=0
Text=REPORT=NO
Text=COMPRESS=12
Text=ERRORLOG=error.txt
Text=BMROOT=Art
Text=BMROOT. . \Art
Text=[FILES]
Text=%FileList%
FileListSyntax=%File%
Text=[ALIAS]
Text=#include <GUIAlias.hh>
Text=%AliasList%
AiiasListSyntax=%Alias%=%Target%
Text=[MAP]
Text=#include <resource.hh>
Text=[WINDOWS]
Text=main=″″, (317,0,494,897),29190,,,f0
Text=[CONFIG]
Text=SetPopupColor(255,255,250)
Text=BrowseButtons( )
#
[pgfTags]
Answer=\s10\sa100\sb100\widctlpar;\f5\fs20
Appendix=\s20\sa120\sb50\keepn\widctlpar;\cf13\b\f5\fs28\kerning28 ;Y3
AppendixTOC=\s30\li360\sa100\sb100\widctlpar;\f5\fs20 ; 3
AxName=\s40\sa120\sb50\keepn\widctlpar;\cf13\b\f5\fs28\kerning28 ;Y3
Body=\s50\sa100\sb100\widctlpar;\f5\fs20 ;
BodyLeft=\s60\sa100\sb100\widctlpar;f5\fs20 ;
BookTitle=\s70\sa120\sb50\keepn\widctlpar;\cf13\b\f5\fs28\kerning28 ;Y1
BookTitleTOC=\s80\1i360\sa100\sb100\widctlpar;\f5\fs20 ;1
Bullet\s90\sa60\sb60\li360\fi-360\widctlpar\tx36;\f5\fs20 ;
Bulleted=\s100\sa60\sb60\fi-360\li360\widctlpar\tx36;\f5\ts20 ;
Bullet2=\s110\sa60\sb60\fi-720\li1440\widctlpar\tx360;\f5\fs20 ;
Bulleted2=\s120\sa60\sb60\fi-720\li1440\widctlpar\tx360;\f5\fs20 ;
Bullet3\s130\sa60\sb60\fi-720\li2180\widctlpar\tx360;\f5\fs20 ;
Bulleted3=\s140\sa60\sb60\fi-720\li2180\widctlpar\tx360;\f5\fs20 ;
Caution=\s150\sa60\sb60\li360\ri360\widctlpar;\f5\fs20 ;
Chap Opening Bullets=\s160\sa60\sbG0\fi-
360\li360\keepn\widctlpar\tx360;f5\fs20 ;
Chapter Opening=\s170\sa110\sb50\keepn\widctlpar;\b\i\f5\fs20 ;
Chapter=\s180\sa120\sb50\keepn\widctlpar;\cf13\b\f5\fs28\kerning28 ;Y3
ChapterTOC=\s190\li360\sa100\sb100\widctlpar;\f5\fs20 ; 3
ChBullet=\s200\sa60\sb60\fi-360\li360\keepn\widctlpar\tx360;\t5\fs20
ChipCellBody=\s210\widctlpar;\f5\fs14 ;
ChipCellBodyC=\s220\qc\widctlpar;\f5\fs14 ;
ChipCellBodyR=\s230\qr\widctlpar;\f5\fs14 ;
ChOpening=\s240\sa110\sb50\keepn\widctlpar;\b\i\f5\fs20
ChName=\s250\sa120\sb50\keepn\widctlpar;\cf13\b\f5\fs28\kerning28 ;Y3
ChNameTOC=\s260\li360\sa100\sb100\widctlpar;\f5\fs20 ;3
ChSubtitle=\s270\sa110\sb50\widctlpar;\b\i\f5\fs20 ;
Code=\s280\li360\widctlpar;\f11\fs18 ;
Code2=\s290\li1440\widctlpar;\f11\fs18 ;
CodeAnnotated=\s300\widctlpar;\f11\fs18 ;
CodeSmall=\s310\li360\widctlpar;\f11\fs18 ;
CommandOptionList=\s320\sa0\sb0\li720\widctlpar;\i\f5\fs20 ;
Example=\s330\sa60\sb60\li360\ri360\widctlpar;\f5\fs20 ;
Example2=\s340\sa60\sb60\li720\ri360\widctlpar;\f5\fs20 ;
FigureTitle=\s350\sa110\sb50\widctlpar;\b\i\f5\fs20 ;
FigureTitleAx=\s360\sa110\sb50\widctlpar;\b\i\f5\fs20 ;
Follow=\s362\sa60\sb60\li720\widctlpar;\f5\fs20 ;
Follow2=\s364\sa60\sb60\li1440\widctlpar;\f5\fs20 ;
Follow3=\s366\sa60\sb60\li2160\widctlpar;\f5\fs20 ;
H2=\s370\sa120\sb50\keepn\widctlpar;\cf13\b\f5\fs28\kerning28 ;Y4
H2TOC=\s380\li720\sa100\sb100\widctlpar;\f5\fs20 ;4
H3=\s390\sa110\sb30\widctlpar;\cf13\b\f5\fs20\kerning28 ;Y5
H3TOC=\s400\li1440\sa100\sb100\widctlpar;\f5\fs20 ;5
H4=\s410\sa110\sb50\widctlpar;\cf13\b\i\f5\fs20 ;
H5=\s420\sa110\sb50\widctlpar;\b\i\f5\fs20 ;
Heading 1=\s430\sa120\sb50\keepn\widctlpar;\cf13\b\f5\fs28\kerning28 ;Y4
heading 1=\s440\sa120\sb50\keepn\widctlpar;\cf13\b\f5\fs28\kerning28 ;Y4
Heading 1TOC=\s450\li720\sa100\sb100\widctlpar;\f5\fs2C ;4
heading 1TOC=\s460\li720\sa100\sb100\widctlpar;\fs\fs20 ;4
Heading 2=\s470\sa110\sb30\widctlpar;\cf13\b\f5\fs20\kerning28 ;Y5
heading 2=\s480\sa110\sb30\widctlpar;\cf13\b\f5\fs20\kerning28 ;Y5
Heading 2TOC=\s490\li1440\sa100\sb100\widctlpar;\f5\fs20 ;5
heading 2TOC=\s500\li1440\sa100\sb100\widctlpar;\f5\fs20 ;5
Heading 3=\s510\sa110\sb50\widctlpar;\cf13\b\i\f5\fs20 ;P6
Heading 4=\s520\sa110\sb50\widctlpar;\b\i\f5\fs20 ;
heading 4=\s530\sa110\sb50\widctlpar;\b\i\f5\fs20 ;
HeadingRefEntry=\s540\sa120\sb50\keepn\widctlpar;\cf13\b\f5\fs28\kerning28
;y4
HeadingRefItem=\s550\sa110\sb50\widctlpar;\b\i\f5\fs20 ;
HeadingRefSubEntry=\s560\sa110\sb30\widctlpar;\cf13\b\f5\fs20\kerning23 ;Y5
HeadingRunIn=\s570\sa110\sb50\widctlpar;\cf13\b\i\fB\fs20 ;P6
HeadingRunInNoPopup=\s580\sa110\sb50\widctlpar;\b\i\f5\fs20 ;
HU=\s590\sa110\sb50\widctlpar;\b\i\f5\fs20 ;
HU-run=\s600\sa110\sb50\widctlpar;\cf13\b\i\f5\fs20 ;P6
HU-run=\s605\sa110\sb50\widctlpar;\cf13\b\i\f5\fs20 ;P6
Information=\s610\li360\sa100\widctlpar;\i\f5\s20 ;N;PopupTitle
Listed=\s620\sa60\sb60\li720\widctlpar;\f5\s20
Listed2=\s630\sa60\sb60\li1440\widctlpar;\f5\fs20 ;
Listed3=\s640\sa60\sb60\li2160\widctlpar;\f5\fs20
MainTitle=\s650\sa120\sb50\keepn\widctlpar;\cf13\b\f5\fs28\kerning28 ;Y2
Note\s660\sa60\sb60\li360\ri360\widctlpar;\f5\fs20 ;
Note2=\s670\sa60\sb60\li720\ri360\widctlpar;\f5\fs20 ;
NoteAlso=\s680\sa60\sb60\li360\ri360\widctlpar;\f5\fs20 ;
Note2Also=\s690\sa60\sb60\li720\ri360\widctlpar;\f5\fs20 ;
Numbered=\s700\sa60\sb60\fi-720\li1440\widctlpar\tx360;\f5\fs20 ;
Numbered2=\s710\sa60\sb60\fi-720\li2180\widctlpar\tx720;\f5\fs20 ;
Numbered2First=\s720\sa60\sb60\fi-720\li2180\widctlpar\tx720;\f5\fs20 ;
NumberedFirst=\s730\sa60\sb60\fi-720\li1440\widctlpar\tx360;\f5\fs20 ;
Popup=\s740\sa100\sb100\widctlpar;\f5\fs20 ;N;PopupText
PopupFirst=\s750\sa100\sb100\widctlpar;\f5\fs20 ;N;PopupText
Question=\s760\sa120\sb50\keepn\widctlpar;\cf13\b\f5\fs28\kerning28 ; Y4
QuestionTOC=\s770\li360\sa100\sb100\widctlpar;\f5\fs20 ;4
RefAnchor=\s776\sa100\sb100\widctlpar;\f5\fs20 ;F5
RefEntry=\s780\sa120\sb50\keepn\widctlpar;\cf13\b\f5\fs28\kerning28 ;Y5
RefEntryTOC=\s790\li1440\sa100\sb100\widctlpar;\f5\fs20 ;5
RefEntrySection=\s800\sa110\sb30\widctlpar;\cf13\b\f5\fs20 ;P6
RefEntryTerm=\s810\sa110\sb50\widctlpar;\b\i\f5\fs20 ;
step1.=\s820\sa60\sb60\fi-720\li1440\widctlpar\tx360;\f5\fs20 ;
StepN.=\s330\sa60\sb60\fi-720\li1440\widctlpar\tx360;\f5\fs20 ;
StepN.1=\s840\sa60\sb60\fi-720\li2180\widctlpar\tx720;\f5\fs20 ;
StepN.N=\s850\sa60\sb60\fi-720\li2180\widctlpar\tx720;\f5\fs20 ;
SubChapter=\s360\sa110\sb50\widctlpar;\b\i\f5\fs20 ;
SubHeading 1=\s870\sa120\sb50\keep\widctlpar;\b\f5\fs28\kerning28 ;
TableFootnote=\s880\sa100\sb100\widctlpar;\f5\fs18 ;
TableTitle=\s890\sa110\sb50\widctlpar;\b\i\f5\fs20 ;
TableTitleAX=\s900\sa110\sb50\widctlpar;\b\i\f5\fs20 ;
Task=\s910\sa100\sb100\fi-360\li720\widctlpar\tx360;\f5\fs20 ;
Task2=\s920\sa100\sb100\fi-720\li1440\widctlpar\tx720;\f5\fs20 ;
TaskIntro=\s930\sa100\sb100\fi-360\li720\widctlpar\tx360;\f5\fs20 ;
TaskIntro2=\s940\sa100\sb100\fi-720\li1440\widctlpar\tx720;\f5\fs20 ;
Term=\s945\sa110\sb50\widctlpar;\cf13\b\i\f5\fs20 ;PG
Title=\s950\sa120\sb50\keepn\widctlpar;\cf13\b\f5\fs28\kerning28 ;Y2
Tagline=\s960\li360\sa100\widctlpar;\i\f5\fs20 ;N;PopupTitle
TopicNoHead=\pard\plain\page\par\s970\sa100\sb100\widctlpar;\f5\fs20 ;
TitleTOC=\s980\sa100\sb100\widctlpar;\fb\fs20 ;2
Warning=\s990\sa60\sb60\li360\ri360\widctlpar;\f5\fs20 ;
#
[fntTags]
Bold=\cs3 ;\b ;]
code=\cs5 ;\i ;}
Caption=\cs7 ;\b ;}
command=\cs9 ;\b ;}
cdfault=\cs11 ;\b\i ;}
Emphasis=\cs21 ;\i ;}
emphasis=\cs31 ;\i ;}
guiLabel=\cs41 ;\b\i ;}
Inline code=\cs47 ;b ;}
input=\cs51 ;\b ;}
key=\cs61 ;\b ;}
linkGuiLabelPopup=\cs71 ;\ul\cf11 ;}
LinkID=\cs81 ;\v\cf14 ;}
LinkJump=\cs91 ;\uldb\cf11 ;}
linkJump=\cs101 ;\uldb\cf11 ;}
LinkPopup=\cs121 ;\ul\cf11 ;}
LinkLiteralPopup=\cs131 ;\ul\cf11 ;}
Literal=\cs141 ;\b\i ;}
literal=\cs143 ;\b\i ;}
ParagraphNumber=\cs151 ;\b ;}
Reference=\cs161 ;\i ;}
Strong=\cs171 ;\b ;}
strong=\cs181 ;\b ;}
term=\cs191 ;\i ;}
textVariable=\cs201 ;\i ;}
title=\cs211 ;\i ;
url=\cs22l ;\b ;}
#
[replacePairs]
\>=>
{=\{
}=\}
\xd4 =′
\q=′
\xd5 =′
\xd2 =″
\xd3 =″
\Q=″
M_CORE=M.CORE
\xed=\{bmc arrow.wmf\}
\xa5=\{bmc reddot.wmf\}
\xa8=\{bmc reddiamond.wmf\}
\xa9=\{bmc redsquarebullet.bmp\}
#
#
#

What is claimed is:

1. A translator for translating a source file in a source format to a target file in a target format, the translator comprising:
a feature identifier to determine a feature set of the source file; and
a feature writer to write the feature set into the target file in the target format.

2. The translator of claim 1, further comprising a storage module to store the feature set.

3. The translator of claim 2, wherein the storage module comprises a buffer.

4. The translator of claim 1, wherein features of the feature set are selected from the group consisting of paragraph style, straddled cells in a table, cross-referencing, pen styles in a drawing, other document formatting, document header specifications, document footer specifications, discontinuity indicators, order indicators, location indicators, beginning indicators, ending indicators, data types, data translation pairs, document macros, implied features, implied feature endings, and combinations thereof.

5. The translator of claim 1, wherein the feature identifier comprises a front-end converter to map code fragments of the source file to a list of features.

6. The translator of claim 5, wherein the front-end converter comprises a front-end lookup table.

7. The translator of claim 6, wherein the front-end lookup table is user modifiable.

8. The translator of claim 1, wherein the feature writer comprises a back-end converter to map the feature set to code fragments of the target file format.

9. The translator of claim 8, wherein the back-end converter comprises a back-end lookup table.

10. The translator of claim 5, comprising a plurality of feature writers to write the feature set into a plurality of target files having a plurality of target formats.

11. The translator of claim 1, comprising a plurality of feature identifiers to determine a feature set of a plurality of source files having a plurality of source formats.

12. The translator of claim 5, wherein the front-end converter comprises a lexical analyzer to identify tokens disposed within the source file, and a feature collector to associate the tokens with the feature set.

13. The translator of claim 1, further comprising a user interface.

14. The translator of claim 13, wherein the user interface comprises a GUI.

15. The translator of claim 1, further comprising a source format adapter module to interface with a source file generator.

16. The translator of claim 15, wherein the source format adapter module enables the source file generator to initiate translation by the translator.

17. The translator of claim 1, further comprising a target file adapter module to perform secondary translation.

18. The translator of claim 17, wherein the target file adapter module translates the target file into another target format.

19. The translator of claim 1, wherein the source and target formats are selected from the group consisting of MIF, RTF, WordPerfect, VENTURA, Microsoft Word, Interleaf, HTML, SGML, XML, C, C++, Visual Basic, Pascal, Java, MFC, PowerPlant, Swing, SVG, HPJ, Flash, WMF, VRML, RenderMan, 3DMF, and combinations thereof.

20. A method of translating a file from a source format to a target format, the method comprising:
(a) identifying a feature set of a source file; and
(b) writing the feature set into a target file in the target format.

21. The method of claim 20, further comprising assembling the feature set in a buffer prior to effecting the writing step (b).

22. The method of claim 20, wherein features of the feature set include at least one of paragraph style, straddled cells in a table, cross-referencing, pen styles in a drawing, other document formatting, document header specifications, document footer specifications, discontinuity indicators, order indicators, location indicators, beginning indicators, ending indicators, data types, data translation pairs, document macros, implied features, implied feature endings, and combinations thereof.

23. The method of claim 20, wherein the identifying step (a) comprises mapping code fragments of the source file to a feature list.

24. The method of claim 23, wherein the identifying step (a) comprises looking up the code fragments in a front-end lookup table.

25. The method of claim 24, further comprising permitting the front-end lookup table to be user modifiable.

26. The method of claim 20, wherein the writing step (b) comprises mapping the feature set to code fragments of the target file format.

27. The method of claim 26, wherein the writing step (b) comprises looking up the feature set in a back-end lookup table.

28. The method of claim 20, wherein the writing step (b) comprises writing the feature set into a plurality of target files having a plurality of target formats.

29. The method of claim 20, wherein the identifying step (a) comprises identifying a feature set of a plurality of source files having a plurality of source formats.

30. The method of claim 20, wherein the identifying step (a) comprises identifying tokens disposed within the source file, and associating the tokens with the feature list.

31. The method of claim 20, further comprising using a source file generator to initiate translation by the translator.

32. The method of claim 20, further comprising using a target file adapter module to perform secondary translation.

33. The method of claim 32, wherein the target file adapter module translates the target file into another target format.

34. A method of configuring a system to translate a source file in a source format to a target file in a target format, the method comprising:
(a) providing a feature identifier to determine a feature set of the source file; and
(b) providing a feature writer to write the feature set into the target file in the target format.

35. A system for translating a source file in a source format to a target file in a target format, the system comprising:
a feature identifier to determine a feature set of the source file; and
a feature writer to write the feature set into the target file in the target format.

36. An article of manufacture for translating a source file in a source format to a target file in a target format, the article of manufacture comprising:
a computer usable medium having a computer readable program code embodied therein, the computer usable medium having:
computer readable program code for identifying a feature set of the source file; and
computer readable program code for writing the feature set into the target file in the target format.

37. Computer readable program code for translating a source file in a source format to a target file in a target format, the computer readable program code comprising:
computer readable program code for identifying a feature set of the source file; and
computer readable program code for writing the feature set into the target file in the target format.

38. A translator for translating a source file in an MIF format to a target file in an HTML format, the translator comprising:
a feature identifier having a front-end lookup table to map MIF code fragments of the source file to a list of features to determine a feature set of the source file;
a buffer to store the feature set; and
a feature writer having a back-end lookup table to map the feature set to HTML code fragments, to write the feature set into the target file in the HTML format.
